(19) United States
(12) Patent Application Publication
(10) Pub. No.: US 2026/0280173 A1
(43) Pub. Date: Sep. 17, 2026

(54) ELASTIC TERMINAL, ELECTRIC CONNECTOR, AND CONDUCTIVE CONNECTION ASSEMBLY FOR CIRCUIT BOARD

(71) Applicant: JONHON OPTRONIC TECHNOLOGY CO., LTD., Luoyang (CN)

(72) Inventors: Luosheng YU, Luoyang (CN); Guoqi ZHOU, Luoyang (CN); Chenhui YANG, Luoyang (CN); Chong WANG, Luoyang (CN); Yang LIN, Luoyang (CN)

(21) Appl. No.: 19/157,285

(22) PCT Filed: Dec. 4, 2023
(86) PCT No.: PCT/CN2023/136150

§ 371 Date: Aug. 15, 2025

(30) Foreign Application Priority Data
Mar. 22, 2023 (CN) 202310285436.9
Jul. 20, 2023 (CN) 202310895812.6

(51) Int. Cl. H01R 13/24; H01R 12/71

(52) U.S. Cl. CPC H01R 13/2414; H01R 12/714; H01R 13/2478; H01R 13/2492

(57) ABSTRACT

An elastic terminal includes a cylindrical body with two ends having conductive contact portions abutted against a mated conductive terminal; and the cylindrical body is of a meshy cylinder structure enclosed by a braided layer braided regularly by conductive filaments, and has an elastic stretching deformation ability in an axial direction by means of a braided structure. The elastic terminal can elastically stretch and deform in the axial direction to achieve an elastic contact to another conductive terminal. A current transmission path is short, there is less surrounding air medium, and high-speed transmission can be achieved. During production of the cylindrical body, the conductive filaments can be braided regularly to form the braided layer by means of a braiding device, and the braided layer with a considerable length can be cut and welded to achieve batch and low-cost production of the terminals.

### TECHNICAL FIELD

The present disclosure relates to the technical field of connectors, in particular to an elastic terminal, an electric connector, and a conductive connection assembly for a circuit board.

### BACKGROUND

An elastic terminal is a commonly used conductive component in an electric connector. At present, common terminals that can achieve longitudinal elastic contact mainly include L-shaped or C-shaped cantilever beam terminals and cylindrical elastic terminals. The L-shaped or C-shaped cantilever beam terminal generally includes a body portion and a cantilever connected to an end portion of the body portion. Only the cantilever portion can undergo elastic deformation. The limitation of such terminal is that if the cantilever is too short, it is easy to yield after compression. If the cantilever is too long, a transmission path is long, which cannot meet a high-speed performance requirement for a low-rise connector, and cannot achieve high-density arrangement. The cylindrical elastic terminal has a spring pin, a wool button, etc. For example, a spring pin connector published in Chinese invention patent with authorization announcement number of CN111403941 B, in which although a transmission rate can reach 112 Gbps, it is assembled from at least four parts which are very small, so that the cylindrical elastic terminal is difficult in mass production, resulting in a high production cost. For example, a wool button connector disclosed in the Chinese invention patent with the authorization announcement number of CN110190428B can achieve a high transmission rate, but the wool button itself has a complicated structure, and there is no rule in winding an internal metal wire during production and manufacturing, resulting in a more complicated winding process, a complicated procedure, low processing efficiency, poor consistency of products, a low production yield, and a high production cost. Moreover, when the metal wire breaks somewhere in use, as surrounding metal wires are only chaotically lapped together, it is also easy to cause unstable signal transmission.

### SUMMARY

An objective of the present disclosure is to provide an elastic terminal, so as to solve the problems of a complicated structure, low processing efficiency, and a high processing cost of an existing cylindrical elastic terminal. Another objective of the present disclosure is to provide an electric connector, so as to solve the problems of a high overall cost of an existing electric connector caused by the complicated structure, the low processing efficiency, and the high processing cost of the elastic terminal. Yet another objective of the present disclosure is to provide a conductive connection assembly for a circuit board, so as to solve the problem of a high cost of an existing conductive connection assembly for the circuit board.

In order to achieve the above objectives, the elastic terminal of the present disclosure employs the following technical solution:

The elastic terminal includes a cylindrical body with two ends having conductive contact portions abutted against a mated conductive terminal; and the cylindrical body is of a meshy cylinder structure enclosed by a braided layer braided regularly by conductive filaments, and has an elastic stretching deformation ability in an axial direction by means of a braided structure.

The beneficial effects are as follows: the present disclosure proposes a completely new elastic terminal, and its cylindrical body is of the meshy cylinder structure enclosed by the braided layer braided regularly by the conductive filaments. Therefore, the elastic terminal can elastically stretch and deform in the axial direction to achieve an elastic contact to another conductive terminal; and a current transmission path is short, there is less surrounding air medium, and high-speed transmission can be achieved. During production of the cylindrical body, the conductive filaments can be braided regularly to form the braided layer by means of a braiding device, and the braided layer with a considerable length can be cut and welded to achieve batch and low-cost production of the terminals, significantly improve production efficiency, and ensure good product consistency and a high qualified rate of products, thereby reducing a production cost.

Further, there are more than two braided layers which are stacked in a radial direction.

The beneficial effects are as follows: by using such arrangement, on one hand, a cross-sectional area of the cylindrical body and a current carrying ability and transmission rate of the terminal can be increased; and on the other hand, a plurality of braided layers are mutually constrained in the radial direction, which can improve an axial elastic deformation ability of the cylindrical body, so that the cylindrical body is more stable and less prone to distortion when subjected to axial force.

Further, adjacent braided layers are alternately stacked, making a radial convex portion formed at one braided layer correspond to a radial concave portion formed at the adjacent braided layer.

The beneficial effects are as follows: such arrangement can make the adjacent braided layers have a large deformation gap therebetween in the radial direction, so as to ensure that the cylindrical body has an enough deformation space if it is squeezed, and ensure a high axial elastic stretching deformation ability; and meanwhile, the adjacent braided layers are closely matched inside and outside, which can better maintain axial stability without distortion under compression. In addition, such arrangement makes arrangement of the conductive filaments more dense; and if the elastic terminal is used as a shielding terminal, its shielding effect is better.

Further, an outermost braided layer has more interlacing points than an inner braided layer.

The beneficial effects are as follows: the more the interlacing points of the braided layers are, the stronger the overall external stability is when braided layers are subjected to an axial load, but the shorter an elastic arm is, and the worse the overall performed elasticity is, so that the outermost braided layer has more interlacing points than the inner braided layer. In such a way, it can not only make the terminal have better elasticity, but also make a structure and a size of the terminal more stable.

Further, two adjacent braided layers are intertwined to form inter-layer interlocking, or two braided layers spaced from each other are intertwined to form multi-layer interlocking.

The beneficial effects are as follows: phenomena of a staggered layer and uneven mechanical properties of the terminal after cutting and welding are avoided, so that the terminal can still maintain stability of the structure and the size in an environment with strong vibration and a large dynamic load.

Further, the cylindrical body is internally provided with a core shaft which is a flexible conductor.

The beneficial effects are as follows: arranging the core shaft inside the cylindrical body can further improve the current carrying ability; and the core shaft is the flexible conductor, which can improve the current carrying ability while ensuring an elastic deformation ability of the terminal in the axial direction.

Further, the core shaft is a stranded wire formed by twisting more than two conductive filaments.

The beneficial effects are as follows: the deformation ability of the stranded wire formed by more than two conductive filaments is stronger, which can not only meet a requirement for improving the current carrying ability of the terminal, but also not weaken an axial deformation ability of the terminal.

Further, end conductive pieces are fixedly connected to two ends of the meshy cylinder structure, and an outer end surface, facing away from the meshy cylinder structure, of each end conductive piece constitutes the conductive contact portion.

The beneficial effects are as follows: by fixedly connecting the end conductive pieces to the two ends of the meshy cylinder structure and using the end conductive pieces to make a conductive contact to another conductive terminal, on one hand, it can protect the two ends of the meshy cylinder structure, so as to avoid the two ends of the meshy cylinder structure from directly contacting to another conductive terminal and avoid shortening the service life due to deformation with frequent squeezing; and on the other hand, it can make conductive contact between the elastic terminal and another conductive terminal more reliable.

Further, the end conductive pieces are hemispherical, and two ends of the meshy cylinder structure are fixedly connected to end surfaces, facing the meshy cylinder structure, of the end conductive pieces.

The beneficial effects are as follows: the end conductive pieces are arranged as hemispheres, spherical surfaces of the end conductive pieces are used for being abutted against another conductive terminal, and the end surfaces, facing the meshy cylinder structure, of the end conductive pieces are used for being fixedly connected with the meshy cylinder structure. In such a way, on one hand, the end conductive pieces are of a simple structure, on the other hand, it is more conducive to ensuring the end conductive pieces to be reliably abutted against the butt conductive terminal. Because the end conductive pieces are hemispherical, it can still ensure a reliable contact in a case of the end conductive pieces being slightly misaligned with the butt conductive terminal.

Further, a radial size of the end surface, facing the meshy cylinder structure, of the end conductive piece is smaller than that of the meshy cylinder structure.

The beneficial effects are as follows: in practical application, a plurality of elastic terminals are usually mounted side by side on a mounting base, so that a plurality of elastic terminals are electrically connected with a plurality of conductive terminals on the circuit board at the same time; and the radial size of the end surface, facing the meshy cylinder structure, of the end conductive piece is smaller than that of the meshy cylinder structure, which can ensure a large spacing between the end conductive pieces of the two adjacent elastic terminals, so that it is more conducive to ensuring a terminal distribution density and electric contact reliability.

Alternatively, an outer end surface, facing away from the meshy cylinder structure, of the end conductive piece is a protruding spherical surface facing away from the meshy cylinder structure.

The beneficial effects are as follows: it is more conducive to ensuring the end conductive piece to be reliably abutted against the butt conductive terminal, especially when the end conductive piece is slightly misaligned with the butt conductive terminal, the reliable contact between the two can still be guaranteed.

Further, the conductive filaments of the braided layer are divided into two group, each of which includes more than two strands which are wound in parallel; the two groups of conductive filaments are helically extended along an axis of the cylindrical body; helical extension directions of the two groups of conductive filaments intersect with each other; and the two groups of conductive filaments are alternately pressed up and down and braided into one layer in the extension directions.

The beneficial effects are as follows: such a braiding method can ensure a stable structure of the formed braided layer and a reliable contact between the conductive filaments, thus ensuring reliable signal transmission of the elastic terminal and making the elastic terminal have a long service life.

The electric connector of the present disclosure employs the following technical solution:

The electric connector includes a mounting base which is provided with a mounting hole penetrating through it; the mounting hole is internally provided with an elastic terminal; the elastic terminal includes a cylindrical body with two ends having conductive contact portions abutted against a mated conductive terminal; and the cylindrical body is of a meshy cylinder structure enclosed by a braided layer braided regularly by conductive filaments, and has an elastic stretching deformation ability in an axial direction by means of a braided structure.

The beneficial effects are as follows: the present disclosure proposes an improved electric connector, and the cylindrical body of its elastic terminal is of the meshy cylinder structure enclosed by the braided layer braided regularly by the conductive filaments. Therefore, the elastic terminal can elastically stretch and deform in the axial direction to achieve the elastic contact to another conductive terminal; and a current transmission path is short, there is less surrounding air medium, and high-speed transmission can be achieved. During production of the cylindrical body, the conductive filaments can be braided regularly to form the braided layer by means of a device, and the braided layer with a considerable length can be cut and welded to achieve batch and low-cost production of the terminals, significantly improve production efficiency, and ensure good product consistency and a high qualified rate of products, thereby reducing a production cost.

Further, there are more than two braided layers which are stacked in a radial direction.

The beneficial effects are as follows: by using such arrangement, on one hand, a cross-sectional area of the cylindrical body and a current carrying ability and transmission rate of the terminal can be increased; and on the other hand, a plurality of braided layers are mutually constrained in the radial direction, which can improve an axial elastic deformation ability of the cylindrical body, so that the cylindrical body is more stable and less prone to distortion when subjected to axial force.

Further, adjacent braided layers are alternately stacked, making a radial convex portion formed at one braided layer correspond to a radial concave portion formed at the adjacent braided layer.

The beneficial effects are as follows: such arrangement can make the adjacent braided layers have a large deformation gap therebetween in the radial direction, so as to ensure that the cylindrical body has an enough deformation space if it is squeezed, and ensure a high axial elastic stretching deformation ability; and meanwhile, the adjacent braided layers are closely matched inside and outside, which can better maintain axial stability without distortion under compression. In addition, such arrangement makes arrangement of the conductive filaments more dense; and if the elastic terminal is used as a shielding terminal, its shielding effect is better.

Further, an outermost braided layer has more interlacing points than an inner braided layer.

The beneficial effects are as follows: the more the interlacing points of the braided layers are, the stronger the overall external stability is when braided layers are subjected to an axial load, but the shorter an elastic arm is, and the worse the overall performed elasticity is, so that the outermost braided layer has more interlacing points than the inner braided layer. In such a way, it can not only make the terminal have better elasticity, but also make a structure and a size of the terminal more stable.

Further, two adjacent braided layers are intertwined to form inter-layer interlocking, or two braided layers spaced from each other are intertwined to form multi-layer interlocking.

The beneficial effects are as follows: phenomena of a staggered layer and uneven mechanical properties of the terminal after cutting and welding are avoided, so that the terminal can still maintain stability of the structure and the size in an environment with strong vibration and a large dynamic load.

Further, the cylindrical body is internally provided with a core shaft which is a flexible conductor.

The beneficial effects are as follows: arranging the core shaft inside the cylindrical body can further improve the current carrying ability; and the core shaft is the flexible conductor, which can improve the current carrying ability while ensuring an elastic deformation ability of the terminal in the axial direction.

Further, the core shaft is a stranded wire formed by twisting more than two conductive filaments.

The beneficial effects are as follows: the deformation ability of the stranded wire formed by more than two conductive filaments is stronger, which can not only meet a requirement for improving the current carrying ability of the terminal, but also not weaken an axial deformation ability of the terminal.

Further, end conductive pieces are fixedly connected to two ends of the meshy cylinder structure, and an outer end surface, facing away from the meshy cylinder structure, of each end conductive piece constitutes the conductive contact portion.

The beneficial effects are as follows: by fixedly connecting the end conductive pieces to the two ends of the meshy cylinder structure and using the end conductive pieces to make a conductive contact to another conductive terminal, on one hand, it can protect the two ends of the meshy cylinder structure, so as to avoid the two ends of the meshy cylinder structure from directly contacting to another conductive terminal and avoid shortening the service life due to deformation with frequent squeezing; and on the other hand, it can make conductive contact between the elastic terminal and another conductive terminal more reliable.

Further, the end conductive pieces are hemispherical, and two ends of the meshy cylinder structure are fixedly connected to end surfaces, facing the meshy cylinder structure, of the end conductive pieces.

The beneficial effects are as follows: the end conductive pieces are arranged as hemispheres, spherical surfaces of the end conductive pieces are used for being abutted against another conductive terminal, and the end surfaces, facing the meshy cylinder structure, of the end conductive pieces are used for being fixedly connected with the meshy cylinder structure. In such a way, on one hand, the end conductive pieces are of a simple structure; on the other hand, it is more conducive to ensuring the end conductive pieces to be reliably abutted against the butt conductive terminal. Because the end conductive pieces are hemispherical, it can still ensure a reliable contact in a case of the end conductive pieces being slightly misaligned with the butt conductive terminal.

Further, a radial size of the end surface, facing the meshy cylinder structure, of the end conductive piece is smaller than that of the meshy cylinder structure.

The beneficial effects are as follows: in practical application, a plurality of elastic terminals are usually mounted side by side on a mounting base, so that a plurality of elastic terminals are electrically connected with a plurality of conductive terminals on the circuit board at the same time; and the radial size of the end surface, facing the meshy cylinder structure, of the end conductive piece is smaller than that of the meshy cylinder structure, which can ensure a large spacing between the end conductive pieces of the two adjacent elastic terminals, so that it is more conducive to ensuring a terminal distribution density and electric contact reliability.

Alternatively, an outer end surface, facing away from the meshy cylinder structure, of the end conductive piece is a protruding spherical surface facing away from the meshy cylinder structure.

The beneficial effects are as follows: it is more conducive to ensuring the end conductive piece to be reliably abutted against the butt conductive terminal, especially when the end conductive piece is slightly misaligned with the butt conductive terminal, the reliable contact between the two can still be guaranteed.

Further, the conductive filaments of the braided layer are divided into two group, each of which includes more than two strands which are wound in parallel; the two groups of conductive filaments are helically extended along an axis of the cylindrical body; helical extension directions of the two groups of conductive filaments intersect with each other; and the two groups of conductive filaments are alternately pressed up and down and braided into one layer in the extension directions.

The beneficial effects are as follows: such a braiding method can ensure a stable structure of the formed braided layer and a reliable contact between the conductive filaments, thus ensuring reliable signal transmission of the elastic terminal and making the elastic terminal have a long service life.

Further, an end portion of the elastic terminal is directly exposed from the mounting hole, or a conductive piece that makes a contact to the conductor and is exposed from the mounting hole is arranged at least one end of the elastic terminal.

The beneficial effects are as follows: it is convenient for the elastic terminal to be abutted against another conductive terminal to achieve an electric contact, especially for the elastic terminal to be abutted against a flat conductive terminal.

Further, an opening at least one end of the mounting hole is of an adduction structure; and the conductive piece is mounted at the adduction opening in the mounting hole, and has an extension end extending out of the adduction opening and an anti-disengagement portion cooperating with a stop of the adduction opening.

The beneficial effects are as follows: by using such arrangement, on one hand, it can prevent the elastic terminal from falling out of the mounting hole; on the other hand, it can axially limit the elastic terminal in the mounting hole, so that lengths of two ends of the mounting hole exposed from the elastic terminal are stable and well consistent.

Alternatively, an inner convex ring is arranged on an inner wall of the mounting hole to clamp the elastic terminal.

The beneficial effects are as follows: by arranging the inner convex ring on the inner wall of the mounting hole, the elastic terminal is clamped in the mounting hole by the inner convex ring; and by means of the such arrangement, the electric connector is of a simple overall structure and has fewer parts.

The conductive connection assembly for the circuit board of the present disclosure employs the following technical solution:

The conductive connection assembly for the circuit board includes an electric connector and a circuit board connected with the electric connector; the electric connector includes a mounting base which is provided with a mounting hole penetrating through it; the mounting hole is internally provided with an elastic terminal; the elastic terminal includes a cylindrical body with two ends having conductive contact portions abutted against a mated conductive terminal; the cylindrical body is of a meshy cylinder structure enclosed by a braided layer braided regularly by conductive filaments, and has an elastic stretching deformation ability in an axial direction by means of a braided structure; the circuit board is fixedly mounted on a surface of a mounting base of the electric connector; and a conductive contact of the circuit board makes a conductive contact to the elastic terminal.

The beneficial effects are as follows: the present disclosure proposes an improved conductive connection assembly for a circuit board, mainly involving an improvement on the electric connector. The cylindrical body of the elastic terminal of the electric connector is of a meshy cylinder structure enclosed by the braided layer braided regularly by the conductive filaments, so that the elastic terminal can elastically stretch and deform in the axial direction to achieve the elastic contact to another conductive terminal; and a current transmission path is short, which can achieve high-speed transmission. During production of the cylindrical body, the conductive filaments can be braided regularly to form the braided layer by means of a device, and the braided layer with a considerable length can be cut and welded to achieve batch and low-cost production of the terminals, significantly improve production efficiency, and ensure good product consistency and a high qualified rate of products, thereby reducing a production cost. On this basis, a production cost of the conductive connection assembly for the circuit board is reduced.

Further, there are more than two braided layers which are stacked in a radial direction.

The beneficial effects are as follows: by using such arrangement, on one hand, a cross-sectional area of the cylindrical body and a current carrying ability and transmission rate of the terminal can be increased; and on the other hand, a plurality of braided layers are mutually constrained in the radial direction, which can improve an axial elastic deformation ability of the cylindrical body, so that the cylindrical body is more stable and less prone to distortion when subjected to axial force.

Further, adjacent braided layers are alternately stacked, making a radial convex portion formed at one braided layer correspond to a radial concave portion formed at the adjacent braided layer.

The beneficial effects are as follows: such arrangement can make the adjacent braided layers have a large deformation gap therebetween in the radial direction, so as to ensure that the cylindrical body has an enough deformation space if it is squeezed, and ensure a high axial elastic stretching deformation ability; and meanwhile, the adjacent braided layers are closely matched inside and outside, which can better maintain axial stability without distortion under compression. In addition, such arrangement makes arrangement of the conductive filaments more dense; and if the elastic terminal is used as a shielding terminal, its shielding effect is better.

Further, an outermost braided layer has more interlacing points than an inner braided layer.

The beneficial effects are as follows: the more the interlacing points of the braided layers are, the stronger the overall external stability is when braided layers are subjected to an axial load, but the shorter an elastic arm is, and the worse the overall performed elasticity is, so that the outermost braided layer has more interlacing points than the inner braided layer. In such a way, it can not only make the terminal have better elasticity, but also make a structure and a size of the terminal more stable.

Further, two adjacent braided layers are intertwined to form inter-layer interlocking, or two braided layers spaced from each other are intertwined to form multi-layer interlocking.

The beneficial effects are as follows: phenomena of a staggered layer and uneven mechanical properties of the terminal after cutting and welding are avoided, so that the terminal can still maintain stability of the structure and the size in an environment with strong vibration and a large dynamic load.

Further, the cylindrical body is internally provided with a core shaft which is a flexible conductor.

The beneficial effects are as follows: arranging the core shaft inside the cylindrical body can further improve the current carrying ability; and the core shaft is the flexible conductor, which can improve the current carrying ability while ensuring an elastic deformation ability of the terminal in the axial direction.

Further, the core shaft is a stranded wire formed by twisting more than two conductive filaments.

The beneficial effects are as follows: the deformation ability of the stranded wire formed by more than two conductive filaments is stronger, which can not only meet a requirement for improving the current carrying ability of the terminal, but also not weaken an axial deformation ability of the terminal.

Further, end conductive pieces are fixedly connected to two ends of the meshy cylinder structure, and an outer end surface, facing away from the meshy cylinder structure, of each end conductive piece constitutes the conductive contact portion.

The beneficial effects are as follows: by fixedly connecting the end conductive pieces to the two ends of the meshy cylinder structure and using the end conductive pieces to make a conductive contact to another conductive terminal, on one hand, it can protect the two ends of the meshy cylinder structure, so as to avoid the two ends of the meshy cylinder structure from directly contacting to another conductive terminal and avoid shortening the service life due to deformation with frequent squeezing; and on the other hand, it can make conductive contact between the elastic terminal and another conductive terminal more reliable.

Further, the end conductive pieces are hemispherical, and two ends of the meshy cylinder structure are fixedly connected to end surfaces, facing the meshy cylinder structure, of the end conductive pieces.

The beneficial effects are as follows: the end conductive pieces are arranged as hemispheres, spherical surfaces of the end conductive pieces are used for being abutted against another conductive terminal, and the end surfaces, facing the meshy cylinder structure, of the end conductive pieces are used for being fixedly connected with the meshy cylinder structure. In such a way, on one hand, the end conductive pieces are of a simple structure; on the other hand, it is more conducive to ensuring the end conductive pieces to be reliably abutted against the butt conductive terminal. Because the end conductive pieces are hemispherical, it can still ensure a reliable contact in a case of the end conductive pieces being slightly misaligned with the butt conductive terminal.

Further, a radial size of the end surface, facing the meshy cylinder structure, of the end conductive piece is smaller than that of the meshy cylinder structure.

The beneficial effects are as follows: in practical application, a plurality of elastic terminals are usually mounted side by side on a mounting base, so that a plurality of elastic terminals are electrically connected with a plurality of conductive terminals on the circuit board at the same time; and the radial size of the end surface, facing the meshy cylinder structure, of the end conductive piece is smaller than that of the meshy cylinder structure, which can ensure a large spacing between the end conductive pieces of the two adjacent elastic terminals, so that it is more conducive to ensuring a terminal distribution density and electric contact reliability.

Alternatively, an outer end surface, facing away from the meshy cylinder structure, of the end conductive piece is a protruding spherical surface facing away from the meshy cylinder structure.

The beneficial effects are as follows: it is more conducive to ensuring the end conductive piece to be reliably abutted against the butt conductive terminal, especially when the end conductive piece is slightly misaligned with the butt conductive terminal, the reliable contact between the two can still be guaranteed.

Further, the conductive filaments of the braided layer are divided into two group, each of which includes more than two strands which are wound in parallel; the two groups of conductive filaments are helically extended along an axis of the cylindrical body; helical extension directions of the two groups of conductive filaments intersect with each other; and the two groups of conductive filaments are alternately pressed up and down and braided into one layer in the extension directions.

The beneficial effects are as follows: such a braiding method can ensure a stable structure of the formed braided layer and a reliable contact between the conductive filaments, thus ensuring reliable signal transmission of the elastic terminal and making the elastic terminal have a long service life.

Further, an end portion of the elastic terminal is directly exposed from the mounting hole, or a conductive piece that makes a contact to the conductor and is exposed from the mounting hole is arranged at least one end of the elastic terminal.

The beneficial effects are as follows: it is convenient for the elastic terminal to be abutted against another conductive terminal to achieve an electric contact, especially for the elastic terminal to be abutted against a flat conductive terminal.

Further, an opening at least one end of the mounting hole is of an adduction structure; and the conductive piece is mounted at the adduction opening in the mounting hole, and has an extension end extending out of the adduction opening and an anti-disengagement portion cooperating with a stop of the adduction opening.

The beneficial effects are as follows: by using such arrangement, on one hand, it can prevent the elastic terminal from falling out of the mounting hole; on the other hand, it can axially limit the elastic terminal in the mounting hole, so that lengths of two ends of the mounting hole exposed from the elastic terminal are stable and well consistent.

Alternatively, an inner convex ring is arranged on an inner wall of the mounting hole to clamp the elastic terminal.

The beneficial effects are as follows: by arranging the inner convex ring on the inner wall of the mounting hole, the elastic terminal is clamped in the mounting hole by the inner convex ring; and by means of the such arrangement, the electric connector is of a simple overall structure and has fewer parts.

### BRIEF DESCRIPTION OF DRAWINGS

FIG. 1 is an overall schematic diagram of embodiment 1 of an elastic terminal of the present disclosure;

FIG. 2 is a schematic diagram of a cylindrical body in FIG. 1;

FIG. 3 is a schematic sectional view of a cylindrical body in FIG. 1;

FIG. 4 is a schematic comparison diagram of braided layers formed by different interlacing structures;

FIG. 5 is a schematic structural diagram of a braided body formed by a 1×1 interlacing structure;

FIG. 6 is a schematic sectional view of a braided body shown in FIG. 5;

FIG. 7 is a schematic structural diagram of a braided body formed by a 2×2 interlacing structure;

FIG. 8 is a schematic sectional view of a braided body shown in FIG. 7;

FIG. 9 is a schematic diagram of mechanical characteristics of a braided layer formed by a 1×1 interlacing structure;

FIG. 10 is a schematic diagram of mechanical characteristics of a braided layer formed by a 2×2 interlacing structure;

FIG. 11 is a schematic structural diagram of a braided body having on core shaft inside and a single braided layer;

FIG. 12 is a schematic sectional view of a braided body shown in FIG. 11;

FIG. 13 is a schematic structural diagram of a braided body having on core shaft inside and double braided layers;

FIG. 14 is a schematic sectional view of a braided body shown in FIG. 13;

FIG. 15 is a schematic structural diagram of a braided body having on core shaft inside and three braided layers;

FIG. 16 is a schematic sectional view of a braided body shown in FIG. 15;

FIG. 17 is a schematic diagram of a braided body formed by nesting double braided layers;

FIG. 18 is a schematic diagram of a braided body formed by nesting three braided layers;

FIG. 19 is a schematic structural diagram of a three-dimensional braided body;

FIG. 20 is a schematic sectional view of a three-dimensional braided body shown in FIG. 19;

FIG. 21 is a space trajectory diagram of a conductive filament of a three-dimensional braided body;

FIG. 22 is a space trajectory diagram of intertwining a conductive filament of a three-dimensional braided body with an adjacent braided layer;

FIG. 23 is a schematic diagram of intertwining a conductive filament of a three-dimensional braided body with an adjacent braided layer from another perspective;

FIG. 24 is a schematic sectional diagram of a braided body having a core shaft inside and a single braided layer;

FIG. 25 is a schematic structural diagram of a braided body having a core shaft inside and double braided layers;

FIG. 26 is schematic structural diagram of a core shaft;

FIG. 27 is a schematic sectional view of a core shaft;

FIG. 28 is a schematic diagram of an end conductive piece being fixedly connected to two ends of a meshy cylinder structure;

FIG. 29 is an overall schematic diagram of embodiment 2 of an elastic terminal of the present disclosure;

FIG. 30 is a side view of an elastic terminal shown in FIG. 29;

FIG. 31 is a schematic diagram of a braided layer shown in FIG. 29;

FIG. 32 is a schematic diagram of two strands of conductive filaments with one conductive filament forming one strand being crosswise winded;

FIG. 33 is a schematic diagram of two strands of conductive filaments with a plurality of conductive filaments forming one strand being crosswise winded;

FIG. 34 is a schematic diagram of a cylindrical body having two braided layers in a radial direction;

FIG. 35 is a schematic diagram of a cylindrical body having one braided layer in a radial direction;

FIG. 36 is an overall schematic diagram of embodiment 1 of an electric connector of the present disclosure;

FIG. 37 is a schematic diagram of an internal structure of an electric connector shown in FIG. 36;

FIG. 38 is an overall schematic diagram of embodiment 2 of an electric connector of the present disclosure;

FIG. 39 is a schematic diagram of an internal structure of an electric connector shown in FIG. 38;

FIG. 40 is an overall schematic diagram of embodiment 3 of an electric connector of the present disclosure;

FIG. 41 is a schematic diagram of an internal structure of an electric connector shown in FIG. 40;

FIG. 42 is a schematic diagram of embodiment 1 of a conductive connection assembly for a circuit board of the present disclosure;

FIG. 43 is a schematic diagram of embodiment 2 of a conductive connection assembly for a circuit board of the present disclosure;

Reference numerals in the drawings: 1. mounting base; 101. mounting hole; 102. limiting step; 103. inner convex ring; 2. cylindrical body; 201. First layer; 202. second layer; 203. third layer; 3. conductive filament; 301. first right-handed conductive filament; 302. second right-handed conductive filament; 303. third right-handed conductive filament; 304. left-handed conductive filament; 4. conductive contact portion; 5. end conductive piece; 6. flange connector conductor; 8. bolt; 9. electric connector; 10. radial convex portion; 11. radial concave portion; 12. core shaft; 13. upper load backplane; 14. upper circuit board; 15. lower circuit board; and 16. lower load backplane.

### DETAILED DESCRIPTION OF THE EMBODIMENTS

A cylindrical body of an elastic terminal of the present disclosure is of a meshy cylinder structure enclosed by a braided layer braided regularly by conductive filaments. Therefore, the elastic terminal can elastically stretch and deform in an axial direction to achieve an elastic contact to another conductive terminal. During production, braiding can be achieved by means of a device, which achieves efficient production, ensures a high qualified rate of products, and reduces a production cost.

The features and performance of the present disclosure are further described in detail in combination with embodiments below.

Embodiment 1 of an elastic terminal of the present disclosure:

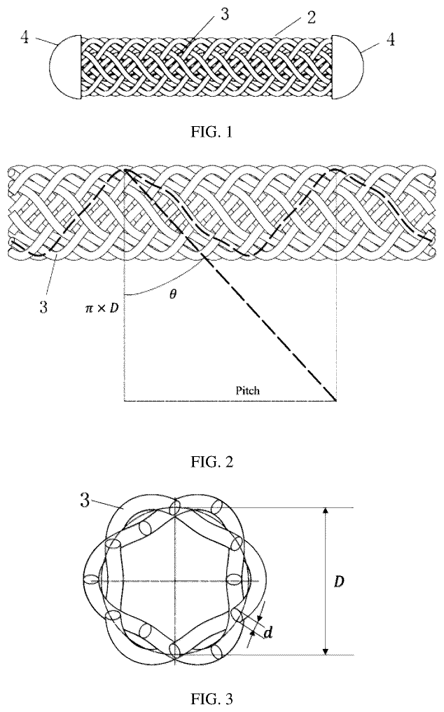

As shown in FIG. 1, the elastic terminal includes a cylindrical body 2 with two ends having conductive contact portions 4 abutted against a mated conductive terminal; and the cylindrical body 2 is of a meshy cylinder structure enclosed by a braided layer braided regularly by a plurality of strands of conductive filaments 3 at a certain angle and gap, and has an elastic stretching deformation ability in an axial direction by means of a braided structure. The conductive filaments 3 forming the braided layer have similar lengths and different phases. The conductive filaments 3 can be beryllium bronze filaments, phosphorus bronze filaments, oxygen-free copper filaments with very fine diameters or made of other conductive materials. As shown in FIG. 2 and FIG. 3, a conductive filament 3 forms a certain angle with a plane perpendicular to an axis of the cylindrical body 2, i.e., a braiding angle θ. The braiding angle θ is related to a diameter D of the cylindrical body 2 and a braiding pitch P. The braiding angle θ, the diameter D of the cylindrical body 2, the braiding pitch P and a diameter d of the conductive filament 3 can be selected as actually needed.

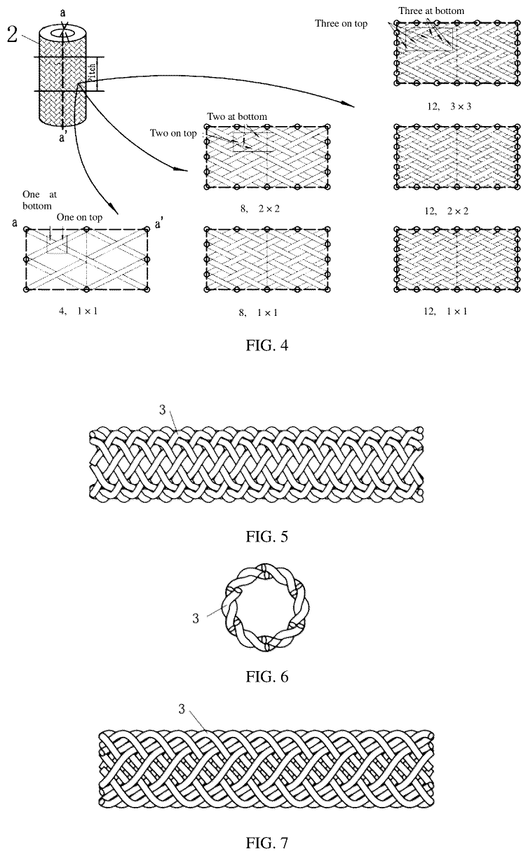

The cylindrical body 2 is a braided body enclosed by a braided layer formed by braiding the conductive filaments 3, and the braided body can have a variety of pattern structures. As shown in FIG. 4, after the braided layer is cut along a cutting line a-a′ and expanded in a circumferential direction, one can see a structure form of the braided layer. An interlaced structure of conductive filaments 3 includes a 1×1 interlaced structure, a 2×2 interlaced structure, and a 3×3 interlaced structure. If there are no more than 4 conductive filaments 3, the 1×1 interlaced structure is needed. If there are more than 4 conductive filaments 3, the 2×2 or 3×3 interlaced structure can be considered.

The three interlaced structures is introduced in detail in combination with the drawings below.

The 1×1 interlaced structure: as shown in FIG. 4, in a circled representative pattern unit, a single-direction conductive filament is on the top, and another conductive filament in an opposite direction is at the bottom. Taking the 1×1 interlaced structure used for four conductive filaments as an example, it can be seen from the drawing that a diagonal conductive filament connected between a lower left corner and an upper right corner is defined as a basic conductive filament; three conductive filaments opposite to a helical direction of the basic conductive filament are a first conductive filament, a second conductive filament, and a third conductive filament from bottom to top. The basic conductive filament penetrates out from the top of the first conductive filament in a case of it being interlaced with the first conductive filament, then penetrates out from the bottom of the second conductive filament in a case of it being interlaced with the second conductive filament, and penetrates out from the top of the third conductive filament in a case of it being interlaced with the third conductive filament.

The 2×2 interlaced structure: as shown in FIG. 4, in a circled representative pattern unit, two single-direction conductive filaments are on the top, and the other two conductive filaments in an opposite direction are at the bottom. Taking the 2×2 interlaced structure used for eight conductive filaments as an example, it can be seen from the drawing that a diagonal conductive filament connected between a lower left corner and an upper right corner is defined as a basic conductive filament; seven conductive filaments opposite to a helical direction of the basic conductive filament are a first conductive filament, a second conductive filament, a third conductive filament, a fourth conductive filament, a fifth conductive filament, a sixth conductive filament, and a seventh conductive filament from bottom to top. The basic conductive filament first penetrates out from the bottom of the first conductive filament, then penetrates out from the tops of the second conductive filament and the third conductive filament, then penetrates out from the bottoms of the fourth conductive filament and the fifth conductive filament, and then penetrates out from the tops of the sixth conductive filament and the seventh conductive filament. That is to say, when the basic conductive filament is intertwined with the conductive filaments in the opposite direction, it is reversed each time passing through two conductive filaments in the opposite direction to complete interlacing once and then form an interlacing point.

The 3×3 interlaced structure: as shown in FIG. 4, in a circled representative pattern unit, three single-direction conductive filament is on the top, and the other three conductive filaments in an opposite direction is at the bottom. Taking the 3×3 interlaced structure used for twelve conductive filaments as an example, it can be seen from the drawing that a diagonal conductive filament connected between a lower left corner and an upper right corner is defined as a basic conductive filament; eleven conductive filaments opposite to a helical direction of the basic conductive filament are a first conductive filament, a second conductive filament, a third conductive filament, a fourth conductive filament, a fifth conductive filament, a sixth conductive filament, a seventh conductive filament, an eighth conductive filament, a ninth conductive filament, a tenth conductive filament, and an eleventh conductive filament from bottom to top. The basic conductive filament first penetrates out from the bottoms of the first conductive filament, the second conductive filament, and the third conductive filament, then penetrates out from the tops of the fourth conductive filament, the fifth conductive filament, and the sixth conductive filament, then penetrates out from the bottoms of the seventh conductive filament, the eighth conductive filament, and the ninth conductive filament, and then penetrates out from the tops of the tenth conductive filament and the eleventh conductive filament. That is to say, when the basic conductive filament is intertwined with the conductive filaments in the opposite direction, it is reversed each time passing through three conductive filaments in the opposite direction to complete interlacing once and then form an interlacing point.

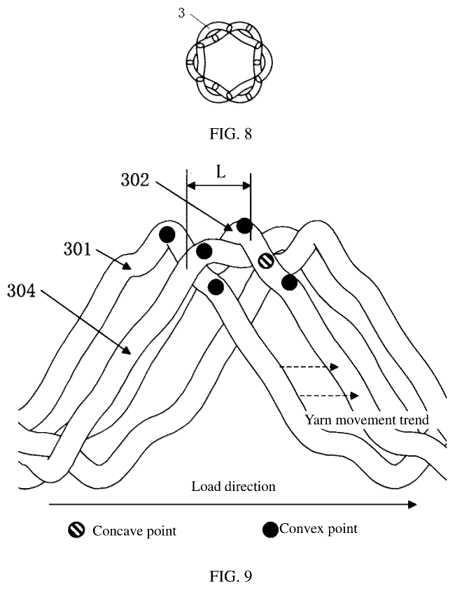

As shown in FIGS. 5-10, structural characteristics and mechanical characteristics of different filament pressing methods of the 1×1 interlaced structure and the 2×2 interlaced structure are compared. For the 1×1 interlaced structure, there are more interlacing points. If the 1×1 interlaced structure is subjected to an axial load, its overall external stability is stronger (advantage), but its elastic arm L is shorter. As shown in FIG. 9, the left-handed conductive filament 304 is interlaced with a first right-handed conductive filament and a second right-handed conductive filament in sequence, first penetrates out from the top of the first right-handed conductive filament 301, and then penetrates out from the bottom of the second right-handed conductive filament 302. The 1×1 interlaced structure performs slightly strong positive force overall and a slightly weak elastic deformation ability (disadvantage). For the 2×2 interlaced structure, its actual interlacing points are half as many as those of the 1×1 interlaced structure. If the 2×2 interlaced structure is subjected to the axial load, its stability to the external overall is weak (disadvantage), but its elastic arm L is longer; and one of every two conductive filaments is relaxed. As shown in FIG. 10, the left-handed conductive filament 304 is interlaced with a first right-handed conductive filament, a second right-handed conductive filament, and a third right-handed conductive filament in sequence, first penetrates out from the tops of the first right-handed conductive filament 301 and the second right-handed conductive filament 302, and then penetrates out from the bottom of the third right-handed conductive filament 303, where the first right-handed conductive filament 301 is relaxed when moving with compression. Therefore, the 2×2 interlaced structure performs weaker positive force to the external overall and a stronger elastic deformation ability (advantage). Similarly, the 3×3 interlaced structure will perform stronger elastic deformation ability and worse stability than the first two structures.

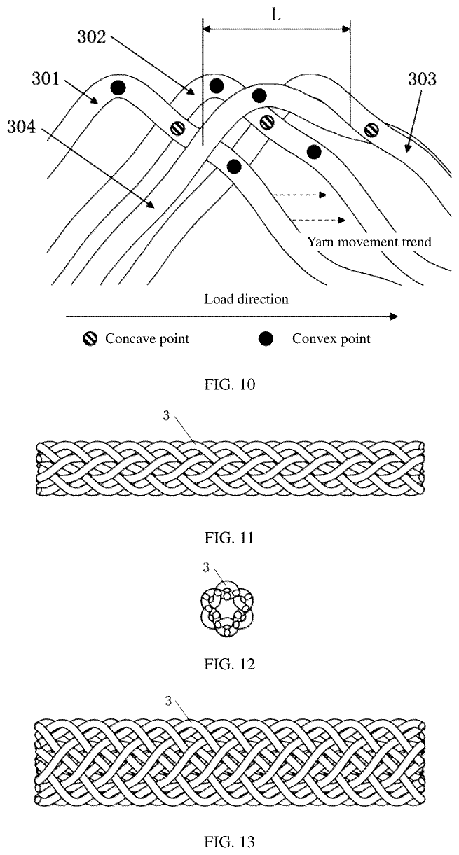

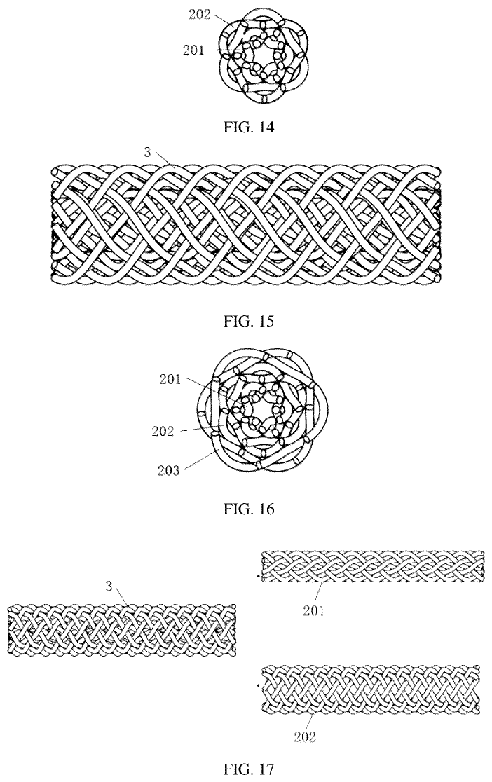

The braided layer of the cylindrical body 2 may be a single layer, as shown in FIGS. 11-12; and there may also be more than two layers, as shown in FIGS. 13-16. Especially in an occasion with a large pin hole spacing, a higher requirement for a current carrying ability and a transmission rate, more braided layers can be used for increasing a diameter of the terminal. An innermost braided layer is defined as a first layer 201, followed sequentially outward by a second layer 202 and a third layer 203. The plurality of braided layers are stacked in the radial direction and constrained each other, so as to improve an axial elastic deformation ability of the cylindrical body 2. An interlaced position of two strands of the conductive filaments 3 forms a radial convex portion 10, and a position without interlacing forms a radial concave portion 11. An area enclosed by four radial convex portions 10 is one radial concave portion 11. The radial convex portions 10 formed at one braided layer due to alternate stacking of adjacent braided layers corresponds to the radial concave portions 11 formed at the adjacent braided layers. Such arrangement can make the adjacent braided layers have a large deformation gap therebetween in the radial direction, so as to ensure that the cylindrical body 2 has an enough deformation space if it is squeezed, and ensure a high axial elastic stretching deformation ability; and meanwhile, the adjacent braided layers are closely matched inside and outside, which can better maintain axial stability without distortion under compression. In addition, such arrangement makes arrangement of the conductive filaments more dense; and if the elastic terminal is used as a shielding terminal, its shielding effect is better.

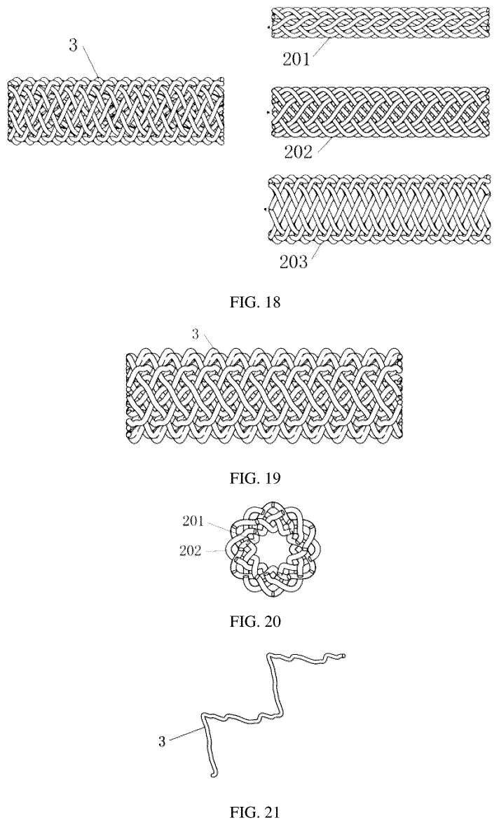

In order to make a structure and a size of the cylindrical body more stable after multiple cycles of compression and resilience, in a case of the braided layer having more than two layers, the outermost braided layer adopts the 1×1 interlaced structure, and the inner braided layer can adopt the 2×2 or 3×3 interlaced structure, as shown in FIGS. 17 and 18. The inner braided layer is of the 2×2 or 3×3 interlaced structure, so that the cylindrical body 2 can maintain good elasticity; while the outermost braided layer is of the 1×1 interlaced structure. Because of a large nominal diameter, it can make up for the disadvantage of elasticity and stabilize the structure and the size of the terminal.

The elastic terminal produced by the previously mentioned method for directly nesting and stacking the braided layers generally has up to three layers. This is because such braiding method features high forming efficiency. But for a case having too many layers, it requires a device to have more braiding discs, which makes the braiding device bulky; and meanwhile, there is no inter-layer interlocking, which will lead to the problems such as a staggered layer and uneven mechanical properties of the terminal after cutting and welding.

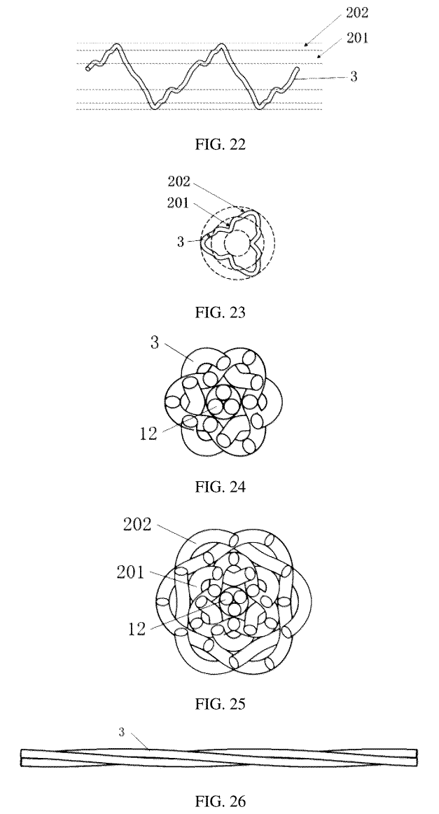

In some working conditions, the terminal needs a considerable current to pass therethrough. The terminal has a diameter of 0.4 mm above, and is in an environment with strong vibration and a large dynamic load; at this time, the elastic terminal produced by the method for directly nesting a plurality of braided layers can no longer meet an application requirement. Therefore, it is necessary to use a three-dimensional braided body with inter-layer interlocking. As shown in FIGS. 19-23, the three-dimensional braided body is a combination of fully integrating two braided layers, where each layer consists of two or three groups of conductive filaments 3 in different directions, which are intertwined with adjacent braided layers by means of the three-dimensional braiding process to form inter-layer interlocking. In a case of the three-dimensional braided body layer having more than three braided layers, in each layer, two or three groups of conductive filaments 3 in different directions may be intertwined with at least one adjacent braided layer by means of the three-dimensional braiding process to form inter-layer interlocking, or two adjacent braided layers spaced from each other are intertwined to form inter-layer interlocking.

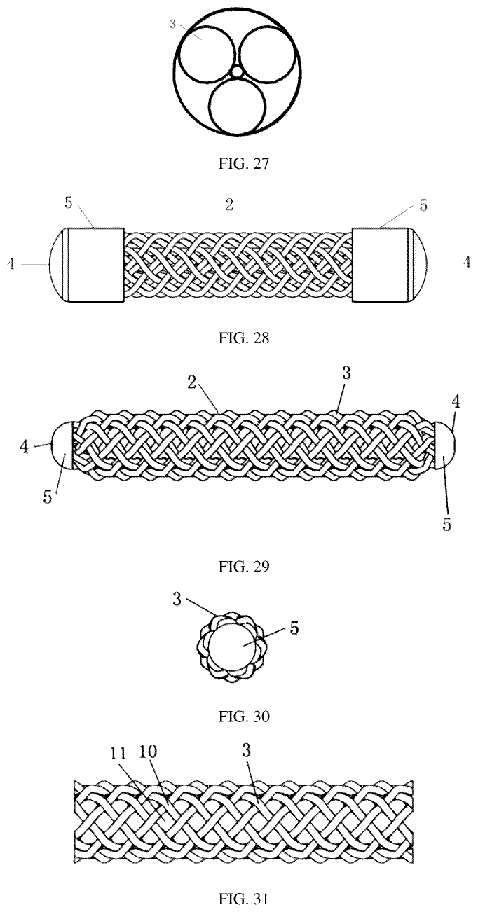

When there is a low required for the current carrying ability of the elastic terminal, the elastic terminal can adopt a core shaft free structure, as shown in FIGS. 11-16. However, in some use environments, there is a high requirement for the current carrying ability of the elastic terminal. In order to improve the current carrying ability of the terminal, a commonly used means include increasing the diameter of the terminal and increasing a filling rate of the terminal. A common approach to increase the filling rate of the terminal is to arrange the core shaft 12 inside the terminal, as shown in FIGS. 24-25. However, a solid copper rod conductor will make the positive force of the terminal become strong under compression, which is not conducive to use. Therefore, it is necessary to change the core shaft 12 to a flexible conductor. As shown in FIGS. 26-27, the core shaft 12 is a stranded wire made of three thin-diameter conductive filaments 3 by stranding. Compared with a single conductive wire of a same diameter, it has a stronger deformation ability and can also participate in conductivity. In such a way, it can not only meet the requirement for improving the current carrying ability, but also does not strength the positive force. In other embodiments, the core shaft 12 can also be made of two or more than four conductive filaments 3 in a certain order and at a certain lay length.

The two ends of the cylindrical body 2 have conductive contact portions 4 used for being abutted against the mated conductive terminal. There are two forms of conductive contact portions 4. One is to machine an end portion of the meshy cylinder structure directly to form a smooth arc surface with a certain radius of curvature, as shown in FIG. 1, where a machining method may be laser welding, ultrasonic welding, copper-dipping or tin-dipping connection, etc.

The other is to add a conductive piece, as shown in FIG. 28. The end conductive pieces 5 are assembled at the two ends of the meshy cylinder structure and are of a structure similar to a fixed cap. A used assembly method may be bonding with a conductive adhesive, tin-dipping soldering, extrusion assembly, etc. Outer end surfaces, facing away from the meshy cylinder structure, of the end conductive pieces 5 are spherical surfaces protruding outward, and the spherical surfaces constitute conductive contact portions 4 for being abutted against the mated conductive terminal. The end conductive piece 5 may be machined and formed by stamping, rolling, machining and other methods. The conductive contact portion 4 of the end conductive piece 5 is the spherical surface, which is more conducive to ensuring the end conductive piece 5 to be reliably abutted against the butt conductive terminal; especially when the end conductive piece 5 is slightly misaligned with the butt conductive terminal, the reliable contact between the two can still be guaranteed. Of course, in other embodiments, the end conductive piece may also be of another structure, such as being hemispherical. A spherical surface of the hemispherical end conductive piece forms the conductive contact portion; and the end conductive piece can also be cylindrical, rectangular or the like.

In using the elastic terminal of the present disclosure, as its cylindrical body is of the meshy cylinder structure enclosed by the braided layers braided by the plurality of conductive filaments at a certain angle and gap, the elastic terminal can elastically stretch and deform in the axial direction to achieve the elastic contact to another conductive terminal; and a current transmission path is relatively short, there is less surrounding air medium, and thus the elastic terminal can be widely applied to a use scenario with a high-speed transmission rate, a high node density, and a low space height. In production and manufacturing, the braided layer may be braided regularly by the braiding device. The braiding device can produce a braided layer with a considerable length at one time, and then can cut and weld the braided layer with the considerable length, so as to achieve batch and low-cost production of the terminals, greatly improve production efficiency, achieve efficient and scale production, and ensure good product consistency and a high qualified rate of products, thereby reducing a production cost. The elastic terminal of the present disclosure may be used as a signal, power supply or shielded grounding terminal.

Embodiment 2 of an elastic terminal of the present disclosure:

As shown in FIGS. 29-30, the elastic terminal includes a cylindrical body 2; the cylindrical body 2 is of a meshy cylinder structure enclosed by a braided layer braided by a plurality of conductive filaments 3 at a certain angle and gap; end conductive pieces 5 are fixedly connected to two ends of the meshy cylinder structure; and the meshy cylinder structure is electrically connected with the end conductive pieces 5. The conductive filament 3 has certain elasticity and strength. As shown in FIG. 31, each strand of conductive filament 3 helically extends along an axis of the cylindrical body 2; the conductive filaments are divided into left-handed conductive filaments and right-handed conductive filaments according to different helical directions, all the left-handed conductive filaments form one group, and all right-handed conductive filaments form one group; helical extension directions of the left-handed conductive filaments and the right-handed conductive filaments intersect with each other; the intersecting conductive filaments 3 are alternately pressed up and down; one conductive filament 3 is at an upper layer at a previous intersection point, so it must be at a lower layer at a next intersection point; an intersecting position of two strands of conductive filaments 3 forms a radial convex portion 10, and a position without intersection forms a radial concave portion 11; and an area enclosed by four radial convex portions 10 is one radial concave portion 11.

In winding the cylindrical body 2, each strand of conductive filament 3 can only include one conductive filament 3, as shown in FIG. 32. Each strand of conductive filament 3 can also include more than two conductive filaments 3, all of which are wound in parallel, as shown in FIG. 33. In addition, a number of the conductive filaments 3 contained in each strand may be same or different.

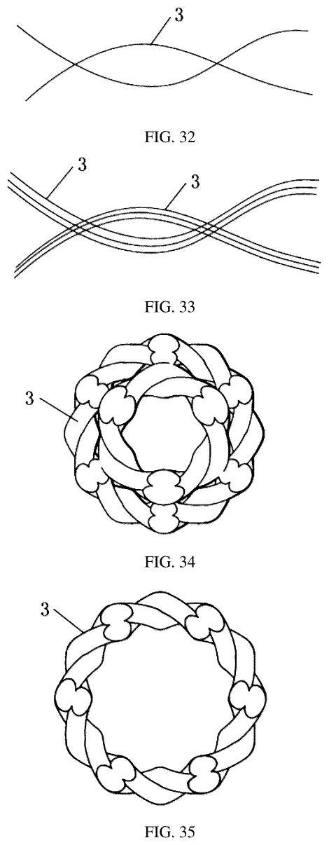

The braided layer can have a single layer, as shown in FIG. 35; it may also have more than two layers, as shown in FIG. 34; and the plurality of braided layers are stacked in the radial direction. The more the number of the braided layers is, the larger the cross-sectional area of the cylindrical body 2 is, and the stronger a through-current capability is; and the plurality of braided layers are mutually constrained in the radial direction, which can further improve the axial elastic deformation ability of the cylindrical body 2. In a case of arranging more than two braided layers, the radial convex portions 10 formed at one braided layer due to alternate stacking of adjacent braided layers correspond to the radial concave portions 11 formed at the adjacent braided layers. Such arrangement can make the adjacent braided layers have a large deformation gap therebetween in the radial direction, so as to ensure that the cylindrical body 2 has an enough deformation space if it is squeezed, and ensure a high axial elastic stretching deformation ability; and meanwhile, the adjacent braided layers are closely matched inside and outside, which can better maintain axial stability without distortion under compression. In addition, such arrangement makes arrangement of the conductive filaments 3 more dense; and if the elastic terminal is used as a shielding terminal, its shielding effect is better.

The end conductive pieces 5 are fixedly connected to the two ends of the meshy cylinder structure. In this embodiment, the end conductive pieces 5 are hemispherical, spherical surfaces of the end conductive pieces 5 face away from the meshy cylinder structure; the two ends of the meshy cylinder structure are gathered to their centers to form connection ends; and the connection ends are fixedly connected to end surfaces, facing the meshy cylinder structure, of the end conductive pieces 5, using laser welding, ultrasonic welding, spot-tin welding, bonding with conductive gel, crimping and squeezing, and other methods. A radial size of the end surface, facing the meshy cylinder structure, of the end conductive piece 5 is smaller than that of the meshy cylinder structure. In a case of mounting a plurality of elastic terminals on one mounting base 1 side by side, it can ensure a large spacing between the end conductive pieces 5 of two adjacent elastic terminals, thereby ensuring a terminal distribution density and electric contact reliability. When in use, the spherical surface of the end conductive piece 5 serves as a conductive contact portion 4 to make a conductive contact to another conductive terminal.

In addition, the single-layer braided layer can also adopt other braiding methods different from the above embodiment. For example, a single-strand conductive filament 3 is wavy, and the two adjacent strands of conductive filaments 3 intersect with each other by means of close wave peaks and wave troughs in a hooking manner. The wave peaks and wave troughs of each strand of conductive filament 3 intersect with an adjacent strand of conductive filament 3, and each conductive filament 3 extends in the axial direction of the cylindrical body 2. A plurality of strands of conductive filaments 3 are interlaced and interconnected in parallel to form a circumference of the entire cylindrical cylinder in an enclosing manner. Of course, the braided layer may further adopt other braiding methods. As long as the conductive filaments 3 are braided according to a certain rule and gap to form the braided layer, braiding can be achieved by the device, thereby improving the production efficiency and reducing processing difficulty and a machining cost.

Several electric connectors of the elastic terminal of the present disclosure are introduced specifically in combination with the drawings below.

Embodiment 1 of an electric connector of the present disclosure:

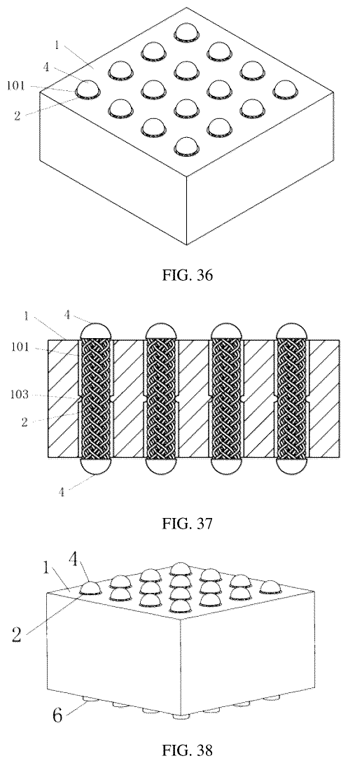

As shown in FIG. 36, the electric connector includes a mounting base 1; the mounting base 1 is a rectangular plate having a certain thickness; four rows of mounting holes 101 are formed in the rectangular plate, with each row having four mounting holes 101; and the mounting holes 101 extend up and down, penetrate through the mounting base 1, and each mounting hole 101 is provided with an elastic terminal inside. An inner convex ring 103 is arranged in the middle of an inner wall of each mounting hole 101, as shown in FIG. 37. The inner convex ring 103 clamps the cylindrical body 2 of the elastic terminal, so that the elastic terminal is fixed in the mounting hole 101, and the two ends of the elastic terminal are exposed from the mounting base 1 by a certain length.

A specific structure of the elastic terminal has been recorded in the above-mentioned embodiment of the elastic terminal of the present disclosure, which will not be repeated here.

Embodiment 2 of an electric connector of the present disclosure:

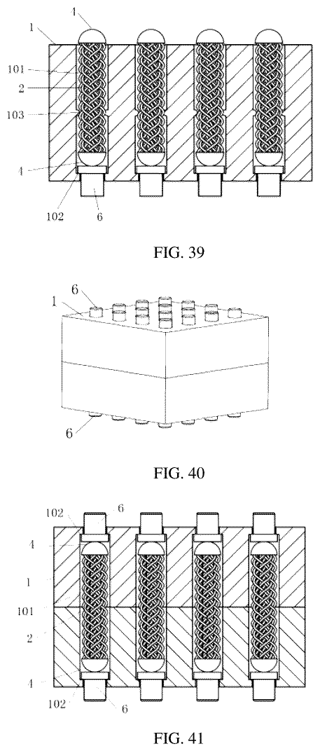

As shown in FIGS. 38-39, the electric connector includes a mounting base 1; the mounting base 1 is a rectangular plate having a certain thickness; four rows of mounting holes 101 are formed in the rectangular plate, with each row having four mounting holes 101; the mounting holes 101 extend up and down, penetrate through the mounting base 1, and each mounting hole 101 is provided with an elastic terminal and a flange connector conductor 6 inside; and the flange connector conductor 6, as a conductive piece, is abutted against the conductive contact portion 4 at a lower end of the elastic terminal and exposed from the mounting hole 101 downward. An opening at a lower end of the mounting hole 101 is of an adduction structure to form a limiting step 102 in the mounting hole 101. The flange connector conductor 6 is mounted at the adduction hole. A flanging structure of the flange connector conductor 6 forms an anti-disengagement portion, which forms stopping fitting to the limiting step 102 in the axial direction, so as to prevent the elastic terminal from falling out from the opening at the lower end of the mounting hole 101, and axially limit one end of the elastic terminal at the same time. In such a way, lengths, exposed from the mounting holes 101, of the end portions of the elastic terminals are stable and well consist. In addition, a conductive contact area of the elastic terminal with another conductive terminal can be changed by adjusting an end area of the flange connector conductor 6. During assembly, the elastic terminal and the flange connector conductor 6 can be bonded together by conductive gel and then charged into the mounting hole 101. The flange connector conductor 6 can also be placed in the mounting hole 101 first, and then the elastic terminal is charged into the mounting hole 101, so that the lower end of the elastic terminal is abutted against the flange connector conductor 6 for use. After assembly, an upper end of the elastic terminal is directly exposed from the mounting hole 101, and the lower flange connector conductor 6 is exposed from the mounting hole 101 downward for the electric contact to another conductive terminal.

A specific structure of the elastic terminal has been recorded in the above-mentioned embodiment of the elastic terminal of the present disclosure, which will not be repeated here.

Embodiment 3 of an electric connector of the present disclosure:

As shown in FIGS. 40-41, the electric connector includes a mounting base 1; the mounting base 1 includes an upper plate and a lower plate; the upper plate and the lower plate are of a same structure, are symmetrically arranged up and down, and each is a rectangular plate having a certain thickness; four rows of through holes are formed in each rectangular plate, with each row having four through holes; the through holes extend up and down, penetrate through the rectangular plate; after combination of the upper plate and the lower plate, the through holes formed in the two rectangular plates correspond one by one and communicate correspondingly; two up-down communicating through holes collectively form one entire mounting hole 101; the mounting hole 101 is provided with an elastic terminal and two flange connector conductors 6 inside; the two flange connector conductors 6, as two conductive pieces, are abutted against the conductive contact portions 4 at upper and lower ends of the elastic terminal; the elastic terminal is entirely contained inside the mounting hole 101; and the two flange connector conductors 6 are exposed from the mounting hole 101 upward and downward. An opening at an upper end and an opening at a lower end of the mounting hole 101 are of an adduction structure to form two limiting steps 102 in the mounting hole 101. The two flange connector conductors 6 are mounted at the two adduction holes. Flanging structures of the two flange connector conductors 6 form anti-disengagement portions, which form stopping fitting to the corresponding limiting steps 102 in the axial direction. Therefore, the elastic terminal can be prevented from falling out from the mounting hole 101, and the two ends of the elastic terminal can be axially limited at the same time. In such a way, lengths, exposed from the mounting hole 101, of the two flange connector conductors 6 at the two ends are stable and well consist. In addition, a conductive contact area of the elastic terminal with another conductive terminal can be changed by adjusting an end area of the flange connector conductor 6. During assembly, the elastic terminal and the two flange connector conductors 6 can be bonded together by the conductive gel and then charged into the mounting hole 101. The flange connector conductors 6 can also be placed in the mounting hole 101 first, and then the elastic terminal is charged into the mounting hole 101, so that the two ends of the elastic terminal are abutted against the two flange connector conductor 6 for use respectively. After assembly, the flange connector conductors 6 at the two ends are exposed from the mounting hole 101 upward and downward, for the electric contact to another conductive terminal.

By adding the flange connector conductors 6 at the two ends of the elastic terminal, and abutting the two ends of the elastic terminal against the flange connector conductors 6 at the corresponding ends to achieve electric communication, electrically connecting the flange connector conductors 6 at the two ends with another conductive terminal can make a height of the connector not limited to the length of the terminal. In such a way, even if the terminal is short, the connector can also have a large height.

A specific structure of the elastic terminal has been recorded in the above-mentioned embodiment of the elastic terminal of the present disclosure, which will not be repeated here.

Embodiment 1 of a conductive connection assembly for a circuit board of the present disclosure:

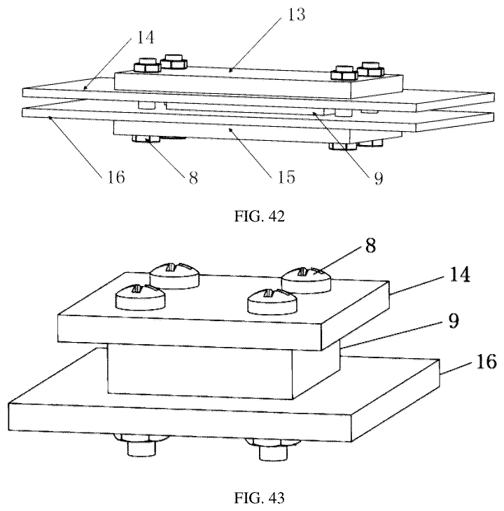

As shown in FIG. 42, the conductive connection assembly for the circuit board includes an electric connector 9, an upper circuit board, a lower circuit board, an upper load backplane, and a lower load backplane. The upper load backplane 13 is located on an upper side of the upper circuit board 14; the lower load backplane 16 is located on a lower side of the lower circuit board 15; the electric connector 9 is placed between the upper circuit board and the lower circuit board; and the upper load backplane 13, the upper circuit board 14, the electric connector 9, the lower circuit board 15, and the lower load backplane 16 are fixedly connected with each other by means of bolts 8. The electric connector 9 includes a mounting base 1 and an elastic terminal mounted in the mounting base 1; conductive contacts on the upper circuit board and the lower circuit board make conductive contacts to the elastic terminal; and then the mounting base 1 can transmit a current between the circuit boards. A specific structure of the electric connector 9 has been recorded in various embodiments of the above-mentioned electric connector 9, which will not be repeated here.

Embodiment 2 of a conductive connection assembly for a circuit board of the present disclosure:

As shown in FIG. 43, the conductive connection assembly for the circuit board includes an electric connector 9, as well as an upper circuit board 14 and a lower circuit board 15 which are connected with the electric connector 9; the electric connector 9 is placed between the upper circuit board and the lower circuit board; the upper circuit board and the lower circuit board are fixedly connected to a surface of a mounting base 1 of the electric connector 9 by means of bolts 8, so as to achieve current transmission between the circuit boards. A specific structure of the electric connector 9 has been recorded in various embodiments of the above-mentioned electric connector 9, which will not be repeated here.

Of course, in specific application, it is also possible to connect the circuit board only on one side of the electric connector, and connect no circuit board on the other side of the electric connector, so that one end of the elastic terminal makes a conductive contact to the circuit board, and the other end is used for connecting with another mated connector.

The foregoing is only preferred embodiments of the present disclosure and is not intended to be limiting of the present disclosure. The protection scope and claims of the patent of the present disclosure are subject to the claims. Any equivalent structure change made by using the contents of the specification and drawings of the present disclosure are similarly embraced by the protection scope of the present disclosure.

1. Elastic terminal, comprising a cylindrical body with two ends having conductive contact portions abutted against a mated conductive terminal; and the cylindrical body is of a meshy cylinder structure enclosed by a braided layer braided regularly by conductive filaments, and has an elastic stretching deformation ability in an axial direction by means of a braided structure.

2. The elastic terminal according to claim 1, wherein there are more than two braided layers which are stacked in a radial direction.

3. The elastic terminal according to claim 2, wherein adjacent braided layers are alternately stacked, making a radial convex portion formed by one braided layer correspond to a radial concave portion formed at the adjacent braided layer.

4. The elastic terminal according to claim 2, wherein an outermost braided layer has more interlacing points than an inner braided layer.

5. The elastic terminal according to claim 2, wherein two adjacent braided layers are intertwined to form inter-layer interlocking, or two braided layers spaced from each other are intertwined to form multi-layer interlocking.

6. The elastic terminal according to claim 1, wherein the cylindrical body is internally provided with a core shaft which is a flexible conductor.

7. The elastic terminal according to claim 6, wherein the core shaft is a stranded wire formed by twisting more than two conductive filaments.

8. The elastic terminal according to claim 1, wherein end conductive pieces are fixedly connected to two ends of the meshy cylinder structure, and an outer end surface, facing away from the meshy cylinder structure, of each end conductive piece constitutes the conductive contact portion.

9. The clastic terminal according to claim 8, wherein the end conductive pieces are hemispherical, and two ends of the meshy cylinder structure are fixedly connected to end surfaces, facing the meshy cylinder structure, of the end conductive pieces.

10. The elastic terminal according to claim 9, wherein a radial size of the end surface, facing the meshy cylinder structure, of the end conductive piece is smaller than that of the meshy cylinder structure.

11. The elastic terminal according of claims 8, wherein an outer end surface, facing away from the meshy cylinder structure, of the end conductive piece is a protruding spherical surface facing away from the meshy cylinder structure.

12. The elastic terminal according to claim 1, wherein the conductive filaments of the braided layer are divided into two group, each of which comprises more than two strands which are wound in parallel; the two groups of conductive filaments helically extend along an axis of the cylindrical body; helical extension directions of the two groups of conductive filaments intersect with each other; and the two groups of conductive filaments are alternately pressed up and down and braided into one layer in the extension directions.

13. An electric connector, comprising a mounting base which is provided with a mounting hole penetrating through the mounting base; and the mounting hole is internally provided with an elastic terminal, characterized in that the elastic terminal is that according to claim 1.

14. The electric connector according to claim 13, wherein an end portion of the elastic terminal is directly exposed from the mounting hole, or a conductive piece that makes a contact to the conductor and is exposed from the mounting hole is arranged at least one end of the elastic terminal.

15. The electric connector according to claim 14, wherein an opening at least one end of the mounting hole is of an adduction structure; and the conductive piece is mounted at the adduction opening in the mounting hole, and has an extension end extending out of the adduction opening and an anti-disengagement portion cooperating with a stop of the adduction opening.

16. The electric connector according to claim 13, wherein an inner convex ring is arranged on an inner wall of the mounting hole to clamp the elastic terminal.

17. A conductive connection assembly for a circuit board, comprising an electric connector and a circuit board connected with the electric connector, wherein the electric connector is that according to claim 13; the circuit board is fixedly mounted on a surface of a mounting base of the electric connector; and a conductive contact of the circuit board makes a conductive contact to the elastic terminal.
